(19) United States
(12) Patent Application Publication
(10) Pub. No.: US 2017/0298305 A1
(43) Pub. Date: Oct. 19, 2017

(54) METHOD OF WASHING TEXTILES IN A WASHING MACHINE WITH ACTIVATING UNIT

(71) Applicant: Henkel AG & Co. KGaA, Duesseldorf (JP)

(72) Inventors: André Haetzelt, Duesseldorf (DE); Iwona Spill, Berlin (DE); Bent Rogge, Duesseldorf (DE)

(73) Assignee: Henkel AG & Co. KGaA, Duesseldorf (DE)

(21) Appl. No.: 15/516,980

(22) PCT Filed: Sep. 30, 2015
(86) PCT No.: PCT/EP2015/072513

§ 371 Date: Apr. 5, 2017

(30) Foreign Application Priority Data
Oct. 10, 2014 (DE) 10 2014 220 622.7

(51) Int. Cl. C11D 11/00; D06F 35/00; C11D 3/39

(52) U.S. Cl. CPC C11D 11/007; D06F 35/006; C11D 3/3927; C11D 11/0017; D06F 35/003

(57) ABSTRACT

The disclosure relates to a method of washing textiles in a washing machine having a washing chamber for accommodating a washing liquid and textiles to be cleaned and having an activating unit possessing an inlet or introduction of washing liquid from the washing chamber into the activating unit and possessing an outlet for guiding washing liquid out of the activating unit into the washing chamber, and additionally having at least one means of activation suitable for setting in motion a process for forming free radicals in the washing liquid within the activating unit, wherein the washing liquid comprises an organic bleach booster compound, especially a zwitterionic 3,4-dihydroisoquinolinium derivative.

### CROSS-REFERENCE TO RELATED APPLICATION

This application is a U.S. National-Stage entry under 35 U.S.C. §371 based on International Application No. PCT/EP2015/072513, filed Sep. 30, 2015, which was published under PCT Article 21(2) and which claims priority to German Application No. 10 2014 220 622.7, filed Oct. 10, 2014, which are all hereby incorporated in their entirety by reference.

### TECHNICAL FIELD

The present disclosure relates to a method for laundering textiles in a washing machine comprising an activation device.

### BACKGROUND

It is known that colored textiles can bleed during the washing process. Depending on the washing temperature, the selected washing program and the laundry detergent used, individual or multiple dyes may be washed out of the textiles in varying degrees. The solute dyes migrate into the washing liquid, which in general is suds, and in this way make contact with other textiles, to which the dyes may be transferred. This results in undesirable discolorations, in particular of light-colored textiles, and in the worst case, for example, can entirely ruin a piece of clothing.

The textile industry today uses a number of different dyes. These dyes vary drastically with respect to the chemical structure thereof, the properties thereof, and the binding thereof to a textile. A distinction can be made, for example, between direct dyes, reactive dyes, disperse dyes, acid acids, vat dyes and others. Different types of woven fabrics, such as cotton, polyamide or polyester, require different types of dyes to effectuate efficient and lasting coloring of these woven fabrics. This wide range of dyes used in the textile industry poses a major challenge in the quest for efficient measures against discoloration.

A variety of efforts have already been made to suppress the bleeding process, in particular in the area of laundry detergent compositions. Laundry detergents intended to be used for laundering colored textiles, for example, are usually mixed with dye transfer inhibitors, which are to prevent dyes from being transferred to other textiles. One disadvantage of these additives is that these are usually only effective against individual or few dyes, but not against a wider spectrum of dyes. Commercial dye transfer inhibitors, for example, exhibit good action with respect to red direct dye, but no action, or only low action, with respect to disperse, acid or vat dyes. Precisely such a wide color spectrum, however, can be found with common household colored laundry, since for efficiency reasons in general at most approximate (light/dark) sorting by colors is carried out, but typically not according to individual dues. So as to achieve an appropriate effectiveness with respect to such a mixture of dyes, it would be necessary to add numerous dye transfer inhibitors to the laundry detergent compositions. However, this would undesirably increase not only the complexity of the laundry detergent formulations, but also the costs for the laundry detergent.

A method for treating stains on textiles is known from the US patent specification U.S. Pat. No. 3,927,967, in which the textiles are subjected to a treatment using a laundry detergent solution, a photoactivator and oxygen and are irradiated with visible light during this treatment process. Such a method, however, is not suitable for treating dyed textiles, in particular for suppressing the bleeding process, since the treatment not only attacks dyes dissolved in the washing liquid, but also the dyes bound to the textiles, causing the textiles to undesirably bleach and lose color.

The international patent application WO 2009/067838 A2 describes a method for cleaning laundry using electrolyzed water by way of oxidative radicals. For this purpose, a water tank is provided in addition to the washing machine. The water present in the tank is electrolyzed by way of an electrolysis unit, thereby becoming enriched with radicals, which are highly reactive and thus, among other things, have a cleaning and disinfecting effect. The water thus treated is then supplied to the actual washing process. The disadvantage here is that the textiles to be laundered come in direct contact with radicals stemming from the electrolyzed water during the washing process, whereby not only soiling on the textiles is attacked, but also the dyes bound to the textiles, which can result in undesirable bleaching of the colors.

Bleaching performance-enhancing 3,4-dihydroisoquinoline derivatives are known from the international patent applications WO 03/104199 A2, WO 2005/047264 A1 and WO 2007/001262 A1.

### BRIEF SUMMARY

A method for laundering textiles in a washing machine is provided herein. The washing machine includes a washing chamber for receiving a washing liquid and textiles to be cleaned The washing machine further includes an activation device, which includes an inlet for introducing washing liquid from the washing chamber into the activation device and an outlet for conducting washing liquid out of the activation device into the washing chamber. The activation device further includes at least one activation component suitable for triggering a process within the activation device for forming free radicals in the washing liquid.

The method includes the step of adding the textiles to be washed into the washing chamber of the washing machine. The method further includes the step of starting a washing cycle. The method further includes the step of introducing washing liquid from the washing chamber into the activation device. The method further includes the step of triggering a process in the activation device for forming free radicals in the washing liquid. The method further includes the step of breaking down dyes present in the washing liquid by way of the free radicals. The method further includes the step of conducting treated washing liquid out of the decolorization reservoir into the washing chamber. The washing liquid includes an organic bleach enhancer compound.

Surprisingly, it was found that the bleaching action of organic bleach enhancer compounds, and in particular of zwitterionic 3,4-dihydroisoquinoline derivatives, with respect to dyes detached from textiles increases when these are used in washing machines that comprise an activation device including an activation component, which is suitable for triggering a process within the activation device for forming free radicals in the washing liquid.

The disclosure thus relates to a method for laundering textiles in a washing machine (1) comprising a washing chamber (2) for receiving a washing liquid and textiles to be cleaned, and comprising an activation device (3), which includes an inlet (4) for introducing washing liquid from the washing chamber (2) into the activation device (3) and an outlet (5) for conducting washing liquid out of the activation device (3) into the washing chamber (2), and which additionally comprises at least one activation component suitable for triggering a process within the activation device (3) for forming free radicals in the washing liquid, comprising the following steps:
adding the textiles to be washed into the washing chamber (2) of the washing machine (1);
starting a washing cycle;
introducing washing liquid from the washing chamber (2) into the activation device (3);
triggering a process in the activation device (3) for forming free radicals in the washing liquid;
breaking down dyes present in the washing liquid by way of the free radicals;
conducting treated washing liquid out of the decolorization reservoir (3) into the washing chamber (2),
   characterized in that the, in particular aqueous, washing liquid comprises an organic bleach enhancer compound.

Organic bleach enhancer compounds are organic compounds that comprise no metals or transition metals, comprise no peroxo groups and in customary washing processes, in the presence of H₂O₂ or H₂O₂ precursors, do not form peroxocarboxylic acids or peroximidic acids by way of a perhydrolysis reaction, and when present in the washing process nonetheless enhance the bleaching performance.

Within the scope of the disclosure, the organic bleach enhancer compound is preferably selected from the compounds of general formula (I),

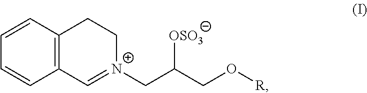

in which R denotes a straight-chain or branched alkyl group having 2 to 20 carbon atoms, and in particular 8 to 12 carbon atoms, and the mixtures thereof. Preferably, the alkyl group R in the compounds of general formula (I) is branched at the 2-position and is in particular selected from the 2-methylhexyl, 2-ethylhexyl, 2-ethylheptyl, 2-propylheptyl, 2-butyloctyl, 2-butylnonyl, 2-pentylnonyl, 2-pentyldecyl and 2-hexyldecyl group and mixtures of these, although the n-dodecyl, n-tetradecyl, n-hexadecyl, n-octadecyl, iso-nonyl, iso-decyl, iso-tridecyl and iso-pentadecyl group and mixtures of these are also possibilities for R. Mixtures of general formula (I) can be produced from 3,4-dihydroisoquinoline, the sulfur trioxide-dimethylformamide complex and glycidyl ethers, as described in WO 03/104199 A2 or WO 2007/001262 A1.

The combination of an organic bleach enhancer compound, and in particular a compound according to general formula (I), and an activation component improves the oxidative destruction of the dyes detached from textiles. The measure as contemplated herein thus minimizes the risk of textile discolorations during the washing process since dyes detached from the textile are oxidatively from the washing liquor and cannot deposit on non-dyed or differently colored textiles, and additionally dyes present on the textile are generally not affected, and the textiles thus do not unacceptably alter the original color thereof as a result of the washing process.

The disclosure thus furthermore relates to the use of the aforementioned compounds for avoiding textile dyes from being transferred from dyed textiles to non-dyed or differently colored textile when these are laundered together in an, in particular surfactant-comprising, aqueous washing liquid in a washing machine (1) comprising a washing chamber (2) for receiving a washing liquid and textiles to be cleaned, and comprising an activation device (3), which includes an inlet (4) for introducing washing liquid from the washing chamber (2) into the activation device (3) and an outlet (5) for conducting washing liquid out of the activation device (3) into the washing chamber (2), and which additionally comprises at least one activation component suitable for triggering a process within the activation device (3) for forming free radicals in the washing liquid.

The washing machine used as contemplated herein can generally be a common household cuboid washing machine having a capacity of approximately 4 to 12 kg of laundry, but other washing machine types, for example industrial washing machine having deviating designs and considerably larger capacities are also possible. The washing chamber is the space through which washing liquid flows during a washing cycle. In a common household washing machine, this is generally a washing drum and the space directly surrounding the same.

It has been shown that the dyes having transferred into the washing liquid during a washing process can be broken down by free radicals, when these cooperate with an organic bleach enhancer compound, and in particular the compound according to general formula (I). Free radicals comprise at least one unpaired electron and, for this reason, are highly reactive and thus have a short live. They are able to react with dyes detached from the textile and present in the washing liquid, and to break these down. By way of example, the decomposition of the dye Acid Orange 7 shall be mentioned, which by the interaction with free radicals is broken down into colorless aromatic by-products, which if necessary in turn can be converted into aliphatic acids by way of further oxidation. A stronger decomposition of the dye molecules takes place in the presence of the organic bleach enhancer compound, and in particular of the compound according to general formula (I).

The washing machine used in the method as contemplated herein takes advantage of this property of free radicals. It comprises an activation device into which the washing liquid from the washing chamber can be conducted. The activation component is disposed in the activation device and is suitable for triggering a process within the activation device for forming free radicals in the washing liquid. The washing liquid thus treated is then conducted together with the organic bleach enhancer compound comprised therein back out of the activation device and into the washing chamber, and is supplied to the further washing process in the washing machine. A stronger decomposition of the dye molecules takes place in the presence of the organic bleach enhancer compound, and in particular of the compound according to general formula (I).

Both the inlet for introducing the washing liquid from the washing chamber into the activation device, and the outlet for conducting the washing liquid out and into the washing chamber are preferably configured such that it is not possible for textiles to find their way into the activation device. For this purpose, the inlet and/or the outlet of the activation device can be equipped with suitable filters or mesh, for example, which textiles cannot pass, while the washing liquid can. It is also possible for the dimensions, and in particular the cross-sectional surface area of the inlet and/or of the outlet, to be configured such that textiles are not able to enter the activation device.

In a preferred embodiment of the disclosure, the activation component comprises a UV radiation source, which is to say the process for forming free radicals in the activation device is triggered by UV irradiation. In this variant embodiment, suds comprising additional chemical components, such as hydrogen peroxide (H₂O₂) or fine-particled titanium dioxide (TiO₂), can be used as the washing liquid. The UV radiation emitted by the radiation source in the activation device causes the hydrogen peroxide or titanium dioxide present in the suds to be activated, and highly reactive hydroxyl radicals (OH radicals) are created as short-lived products of this reaction, which together with the organic bleach enhancer compound are able to deliver the desired dye transfer inhibition performance. If present, the concentration of hydrogen peroxide in the washing liquid is preferably about 0.1 to about 50 mmol/l, and particularly preferably about 1 to about 20 mmol/l.

A quartz lamp or a UV light-emitting diode can be used as the UV radiation source. Other UV radiation sources such as gas discharge lamps, fluorescent lamps or lasers, however, are also conceivable.

If a UV radiation source is present as the activation component, it is generally preferred for this source to be disposed such in the activation device and/or for the activation device to be configured such that no direct UV radiation enters the washing chamber, so that dyes in the textiles present in the washing chamber are not damaged. This can take place, for example, by providing a panel or a curve at the inlet and the outlet in the direction of the washing chamber, forcing the washing liquid to flow around the panel or around the curve. The inlets and outlets of the activation device can be disposed in a direction that does not point in the direction of the washing chamber.

The preferred wavelength range of the emitted UV radiation is in the range of about 100 nm to about 400 nm, with about 250 nm to about 400 nm being particularly preferred.

In an alternative embodiment of the disclosure, the activation component comprises an electrode array, comprising an anode and a cathode. In this case, the free radicals are formed in the washing liquid by way of an electrochemical process. For this purpose, the anode and the cathode can be introduced into the activation device, and each can be connected to the positive or negative pole of a DC voltage source. Without being bound to this hypothesis, it is conceivable that the onsetting electrolysis will then split the water present in the washing liquid, forming OH radicals. The anode used can be, for example, an electrode made of graphite, steel, diamond, noble metals such as platinum or metal oxides or metal oxide mixtures. It is particularly preferred to use a possibly boron-doped diamond electrode as the anode. This generally involves a base body made of plastic material, metal or a semiconductor, such as silicon, which is coated with a thin, polycrystalline diamond layer. So as to achieve sufficient conductivity for the electrolysis, the diamond layer is doped with boron during production.

The effective surface area of the anode is preferably in the range of about 1 cm² to about 500 cm², and particularly preferably between about 2 cm² and about 100 cm². The electrolysis is preferably carried out at current intensities in the range of about 0.01 A to about 30 A, and preferably about 0.1 A to about 10 A.

The two aforementioned variant embodiments comprising a UV radiation source or electrode array as the activation component, in combination with the organic bleach enhancer compound, each already supply good results per se. Nonetheless, it is also possible as contemplated herein to combine the two variants so as to achieve even better bleaching performance. To this end, for example, both the UV radiation source and the electrode array can be disposed in a shared activation device. Alternative, a series or parallel connection of two activation devices, each comprising an activation component, is conceivable.

Preferably, at least one pump is provided in the washing machine used as contemplated herein, which pumps the washing liquid out of the washing chamber and into the activation device and/or out of the same.

The onset, the intensity, and the duration of the process for forming free radicals in the activation device can preferably be regulated. For example, the onset of the process can be coupled to achieving certain operating parameters, such as to a particular temperature of the washing liquid or a particular phase of the washing cycle. For a temperature-dependent regulation, a temperature sensor may be provided, for example, which can detect the temperature of the washing liquid. It is also possible for a purely time-based regulation to be provided, which prompts the radical forming process to start at a pre-set point in time. Likewise, the duration of the process can be set such that this process stops as soon as a certain bleaching result has been achieved. It is also possible for the onset of the process to be completely suppressed for washing cycles with textiles having no bleachable soiling and/or at a particularly low temperature at which it is not to be feared that dyes will wash out into the washing liquid. At high washing temperatures and when laundering particularly heavily soiled textiles, in contrast, the intensity and the duration of the process can be accordingly increased.

The temperature of the washing liquid at which the method as contemplated herein can be operated can be, if desired, in the range of about 10° C. to about 100° C., and preferably of about 20° C. to about 60° C. The activation device is preferably operated over a period of about 1 minute to about 240 minutes, and in particular of about 10 minutes to about 60 minutes.

According to one embodiment of the disclosure, the activation device can be fixedly installed in a housing of the washing machine. The power supply for the activation component and optionally for the pump can be coupled to the power supply of the washing machine. The activation device can be attached beneath the drum or on the inside of the door of the washing machine, for example. Appropriate lines, which can be connected to the inlet and the outlet of the activation device, can be provided in the washing machine to conduct the washing liquid into the activation device and back out of the same. For example, the washing chamber can comprise a washing liquid outlet, which can be connected to the inlet of the activation device. Accordingly, the outlet of the activation device can be connectable to a washing liquid inlet of the washing chamber, so that the treated washing liquid can be conducted out of the activation device and back into the washing chamber.

Alternatively, the activation device can also be designed as a separate, preferably battery-powered module. This can be attached to the inside of the door of the washing machine by way of an appropriate mounting, for example. The advantage of a separately introducible module is that this can be used only when needed and consequently is subject to less wear. Moreover, a separate module can also be installed subsequently into an existing washing machine, or can be removed from a defective washing machine and installed into a new washing machine.

### BRIEF DESCRIPTION OF THE DRAWINGS

The present disclosure will hereinafter be described in conjunction with the following drawing figures, wherein like numerals denote like elements, and:

FIG. 1 shows a schematic representation of an exemplary embodiment of the activation device;

FIG. 2 shows a schematic representation of an alternative embodiment of the activation device;

FIG. 3 shows a schematic view of a washing machine comprising the activation device from FIG. 1; and

FIG. 4 shows a schematic view of a washing machine comprising the activation device from FIG. 2.

### DETAILED DESCRIPTION

The following detailed description is merely exemplary in nature and is not intended to limit the disclosure or the application and uses of the subject matter as described herein. Furthermore, there is no intention to be bound by any theory presented in the preceding background or the following detailed description.

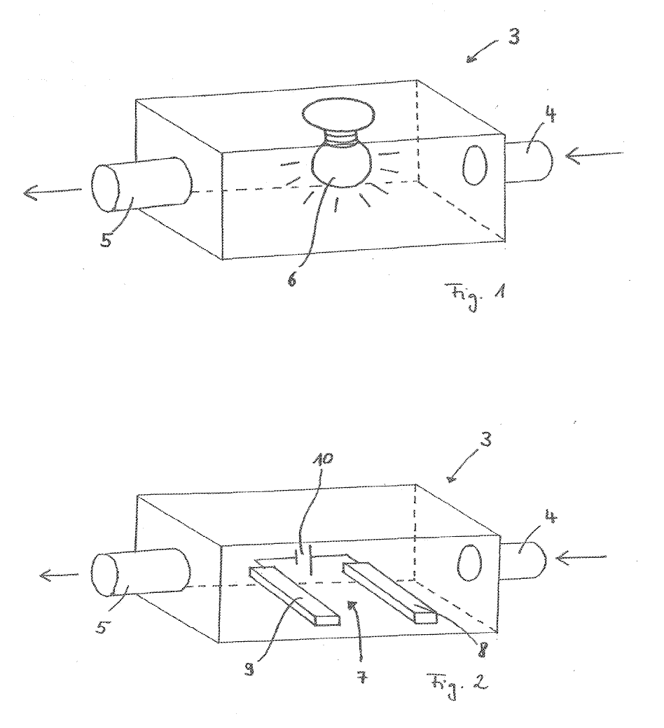

FIG. 1 shows an exemplary embodiment of an activation device denoted in the overall by reference numeral 3, which is suitable for receiving washing liquid. For this purpose, the activation device 3 comprises an inlet 4 and an outlet 5. Washing liquid, which is not shown, can find its way from the environment of the activation device 3 into the interior space thereof through the inlet 4. The washing liquid can exit the activation device 3 again via the outlet 5. The flow direction of the washing liquid is schematically indicated by arrows.

A UV radiation source 6 is situated inside the activation device 3. The arrangement of the UV radiation source 6 inside the activation device 3 is shown only schematically in FIG. 1, and in particular the representation of the electrical connections of the UV radiation source 6 were dispensed with. The UV radiation source 6 can be a UV quartz lamp, which emits UV radiation having a wavelength of about 254 nm.

If a washing liquid comprising hydrogen peroxide or fine-particled titanium dioxide is now introduced through the inlet 4 into the activation device 3, H₂O₂ molecules are activated by the UV radiation emitted by the quartz lamp, creating short-lived, highly reactive hydroxyl radicals. Together with the washing liquid, these are conducted back out of the activation device 3 through the outlet 5 can develop the bleaching action in cooperation with the organic bleach enhancer compound, and in particular the compound according to general formula (I).

FIG. 2 shows an alternative embodiment of the activation device 3. Identical components are denoted by identical reference numerals and, to avoid repetition, are not described again separately. An electrode array 7, which is composed of an anode 8 and a cathode 9, is located inside the activation device 3 shown in FIG. 2.

The anode 8 is connected to the positive pole of an electrical DC voltage source, and the cathode 9 is connected to the negative pole. The representation of the electrode array is again only schematic. The anode 8 can be a boron-doped diamond anode, and the cathode 9 can be a stainless steel electrode. When washing liquid enters the activation device 3 via the inlet 4, the water present in the washing liquid undergoes electrolysis. This results in the creation of hydroxyl radicals, which similarly to the exemplary embodiment already shown for FIG. 1, can be conducted out of the activation device 3 via the outlet 5.

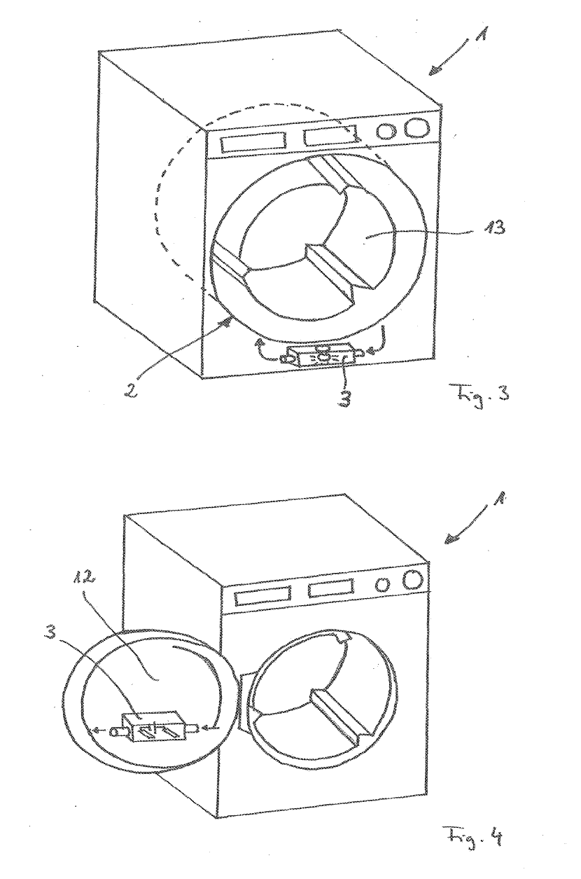

FIGS. 3 and 4 each show a washing machine comprising an activation device.

The washing machine 1 shown in simplified form in FIG. 3 comprises a drum 13, which is part of a washing chamber 2 and beneath which the activation device 3 according to FIG. 1, comprising a UV quartz lamp, is disposed. The washing chamber 2 is composed of the washing drum 13 and the space directly surrounding the same, through which the washing liquid flows during the washing process. The flow of liquid through the activation device 3 is indicated by arrows. It is likewise possible to dispose the activation device 3 in the alternative embodiment together with the electrode array 7 in a region beneath the drum 13. In the example shown, the activation device 3 is an integral part of the washing machine 1.

Alternatively, the activation device 3 can also be disposed in the region of a door 12 of the washing machine 1, as shown in FIG. 4. In FIG. 4, the activation device 3 is mounted on the inside of the door 12 of the washing machine 1. The example shown is the embodiment of the activation device 3 comprising the electrode array 7. It is also possible, of course, to mount the embodiment of the activation device 3 comprising the UV radiation source 6 in the region of the door 12 of the washing machine 1. In this example, the activation device 3 is introduced into the washing machine 1 as a separate, battery-powered module and can be removed, if necessary.

The use as contemplated herein and the method as contemplated herein are preferably carried out at temperatures in the range of about 10° C. to about 95° C., in particular about 20° C. to about 60° C., and particularly preferably at temperatures below 30° C. The water hardness of the water used to prepare the aqueous liquor is preferably in the range of 0° dh to about 21° dH, and in particular 0° dH to about 3° dH. The water hardness in the washing liquor is preferably in the range of 0° dH to about 23° dH, and in particular 0° dH to about 6° dH, which can be achieved by using customary builder materials or water softeners, for example. The use as contemplated herein and the method as contemplated herein are preferably carried out at pH values in the range of about pH 2 to about pH 13, and in particular about of pH 7 to about pH 11.

The organic bleach enhancer compound, and in particular the compound of general formula I), can be introduced into the washing machine in addition to a laundry detergent that otherwise has a customary composition; however, preferably, it can be part of the laundry detergent used in the method as contemplated herein and within the scope of the use as contemplated herein. The concentration of the organic bleach enhancer compound in the, in particular aqueous, washing liquid is preferably in the range of about 0.5 μmol/l to about 500 μmol/l, and in particular of about 5 μmol/l to about 200 μmol/l. So as to create the, in particular aqueous, washing liquid, preferably a laundry detergent comprising an organic bleach enhancer compound, and in particular a compound according to general formula (I), is used.

In addition to the organic bleach enhancer compound, which is preferably present in amounts of about 0.001 wt. % to about 2 wt. %, and in particular about 0.03 wt. % to about 0.2 wt. %, a laundry detergent used within the scope of the present invention can comprise customary ingredients that are compatible with this component.

Laundry detergents, which may be present in particular in the form of powdery solids, in post-compacted particle form, as homogeneous solutions or suspensions, can, in principle, comprise all known ingredients common in such detergents, in addition to the active ingredient used as contemplated herein. The detergents as contemplated herein can in particular comprise builder substances, surfactants, bleaching agents based on organic and/or inorganic peroxygen compounds, other bleach activators, water-miscible organic solvents, enzymes, sequestering agents, electrolytes, pH regulators and further auxiliary agents, such as optical brighteners, graying inhibitors, foam regulators, dyes and odorants.

The detergents preferably comprise one or more surfactants, wherein in particular anionic surfactants, non-ionic surfactants, and the mixtures thereof, but also cationic, zwitterionic and amphoteric surfactants may be used.

Suitable non-ionic surfactants are in particular alkylglycosides and ethoxylation and/or propoxylation products of alkylglycosides or linear or branched alcohols, each having 12 to 18 carbon atoms in the alkyl part and 3 to 20, preferably 4 to 10 alkyl ether groups. Furthermore, corresponding ethoxylation and/or propoxylation products of N-alkyl amines, vicinal diols, fatty acid esters and fatty acid amides, which with respect to the alkyl part correspond to the described long-chain alcohol derivatives, and of alkyl phenols having 5 to 12 carbon atoms in the alkyl group may be used.

Alkoxylated, advantageously ethoxylated, in particular primary alcohols having preferably 8 to 18 carbon atoms and on average 1 to 12 moles ethylene oxide (EO) per mole of alcohol, in which the alcohol residue can be linear or preferably methyl-branched at the 2-position or can comprise linear and methyl-branched residues in the mixture, such as those usually present in oxo alcohol groups, are preferred as non-ionic surfactants. However, in particular, alcohol ethoxylates comprising linear groups of alcohols of native origin having 12 to 18 carbon atoms, for example of coconut, palm, tallow fatty or oleyl alcohol, and an average of 2 to 8 EO per mole of alcohol are preferred. The preferred ethoxylated alcohols include, for example, C₁₂-C₁₄ alcohols having 3 EO or 4 EO, C₉-C₁₁ alcohols having 7 EO, C₁₃-C₁₅ alcohols having 3 EO, 5 EO, 7 EO, or 8 EO, C₁₂-C₁₈ alcohols having 3 EO, 5 EO, or 7 EO, and mixtures thereof, such as mixtures of C₁₂-C₁₄ alcohol having 3 EO and C₁₂-C₁₈ alcohol having 7 EO. The degrees of ethoxylation indicated represent statistical averages that can correspond to an integer or a fractional number for a specific product. Preferred alcohol ethoxylates exhibit a restricted distribution of homologs (narrow range ethoxylates, NRE). In addition to these non-ionic surfactants, fatty alcohols having more than 12 EO can also be used. Examples of these are (tallow) fatty alcohols having 14 EO, 16 EO, 20 EO, 25 EO, 30 EO or 40 EO. Extremely foamable compounds are typically used in particular in detergents for use in mechanical processes. These preferably include C₁₂-C₁₈ alkyl polyethylene glycol/polypropylene glycol ethers, each having up to 8 moles ethylene oxide and propylene oxide units in the molecule. It is also possible, however, to use other known low-foam non-ionic surfactants, such as C₁₂-C₁₈ alkyl polyethylene glycol/polybutylene glycol ethers, each having up to 8 moles ethylene oxide and butylene oxide units in the molecule, and end group-capped alkyl polyalkylene glycol mixed ethers. Particularly preferred are also the hydroxyl group-comprising alkoxylated alcohols, known as hydroxy mixed ethers. The non-ionic surfactants also include alkyl glycosides of the general formula RO(G)ₓ, where R represents to a primary straight-chain or methyl-branched, in particular methyl-branched at the 2-position, aliphatic group having 8 to 22, preferably 12 to 18 carbon atoms, and G denotes a glycose unit having 5 or 6 carbon atoms, preferably glucose. The degree of oligomerization x, which indicates the distribution of monoglycosides and oligoglycosides, is an arbitrary number, which as a quantity to be analytically determined may also take on fractional values, between 1 and 10; x is preferably about 1.2 to about 1.4. Likewise suitable are polyhydroxy fatty acid amides of formula

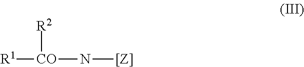

in which R¹CO denotes an aliphatic acyl group having 6 to 22 carbon atoms, R² denotes hydrogen, an alkyl or hydroxyalkyl group having 1 to 4 carbon atoms, and [Z] denotes a linear or branched polyhydroxyalkyl group having 3 to 10 carbon atoms and 3 to 10 hydroxyl groups.

The polyhydroxy fatty acid amides are preferably derived from reducing sugars having 5 or 6 carbon atoms, and in particular from glucose. The group of polyhydroxy fatty acid amides also includes compounds of formula

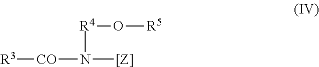

in which R³ denotes a linear or branched alkyl or alkenyl group having 7 to 12 carbon atoms, R⁴ denotes a linear, branched or cyclic alkylene group or an arylene group having 2 to 8 carbon atoms, and R⁵ denotes a linear, branched or cyclic alkyl group or an aryl group or an oxy alkyl group having 1 to 8 carbon atoms, wherein C₁-C₄ alkyl or phenyl groups are preferred, and [Z] denotes a linear polyhydroxy alkyl group, the alkyl chain of which is substituted with at least two hydroxyl groups, or alkoxylated, preferably ethoxylated or propoxylated, derivatives of this group. [Z] is again preferably obtained by the reductive amination of a sugar, such as glucose, fructose, maltose, lactose, galactose, mannose or xylose. The N-alkoxy- or N-aryloxy-substituted compounds can be converted, in the presence of an alkoxide as the catalyst, to the desired polyhydroxy fatty acid amides by reacting these compounds with fatty acid methyl esters. Another class of non-ionic surfactants that is preferably used, which can be used either as the sole non-ionic surfactant or in combination with other non-ionic surfactants, in particular together with alkoxylated fatty alcohols and/or alkyl glycosides, is alkoxylated, preferably ethoxylated or ethoxylated and propoxylated, fatty acid alkyl esters, preferably having 1 to 4 carbon atoms in the alkyl chain, in particular fatty acid methyl esters. Non-ionic surfactants of the amine oxide type, for example N-cocoalkyl-N—N-dimethylamine oxide and N-tallowalkyl-N,N-dihydroxyethylamine oxide, and of the fatty acid alkanolamide type may also be suitable. The quantity of these non-ionic surfactants is preferably no more than that of the ethoxylated fatty alcohols, in particular no more than half thereof. Further possible surfactants are those known as gemini surfactants. These are generally understood to mean compounds that comprise two hydrophilic groups per molecule. These groups are generally separated from one another by a so-called “spacer.” This spacer is in general a carbon chain, which should be long enough for the hydrophilic groups to have sufficient distance from one another to be able to act independently of one another. Such surfactants are generally characterized by an unusually low critical micelle concentration and the capability of drastically reducing the surface tension of the water. In exceptions, the expression ‘gemini surfactants’ is understood to mean not only such “dimeric,” but also corresponding “trimeric” surfactants. Suitable gemini surfactants are, for example, sulfated hydroxy mixed ethers or dimer alcohol bis- and trimer alcohol tris-sulfates and -ether sulfates. End group-capped dimeric and trimeric mixed ethers are characterized in particular by the bifunctionality and multifunctionality thereof. The above-mentioned end group-capped surfactants, for example, exhibit good wetting properties, while being low-foaming, whereby they are suitable in particular for use in mechanical washing or cleaning processes. However, it is also possible to use gemini polyhydroxy fatty acid amides or poly-polyhydroxy fatty acid amides.

Suitable anionic surfactants are in particular soaps and those that comprise the sulfate or sulfonate groups. Surfactants of the sulfonate type that can be used are preferably C₉-C₁₃ alkylbenzene sulfonates, olefin sulfonates, which is to say mixtures of alkene and hydroxyalkane sulfonates, and disulfonates, as they are obtained, for example, from C₁₂-C₁₈ monoolefins having a terminal or internal double bond by way of sulfonation with gaseous sulfur trioxide and subsequent alkaline or acid hydrolysis of the sulfonation products. Also suited are alkane sulfonates obtained from C₁₂-C₁₈ alkanes, for example by way of sulfochlorination or sulfoxidation with subsequent hydrolysis or neutralization. Also suitable are esters of α-sulfo fatty acids (ester sulfonates), for example the α-sulfonated methyl esters of hydrogenated coconut, palm kernel or tallow fatty acids, which are produced by the α-sulfonation of methyl esters of fatty acids of vegetable and/or animal origin having 8 to 20 carbon atoms in the fatty acid molecule and subsequent neutralization to yield water-soluble mono-salts. Preferably, these are the α-sulfonated esters of hydrogenated coconut, palm, palm kernel or tallow fatty acids, wherein it is also possible for sulfonation products of unsaturated fatty acids, such as oleic acid, to be present in small amounts, and preferably in amounts not above approximately about 2 to about 3 wt. %. In particular, α-sulfo fatty acid alkyl esters that comprise an alkyl chain having no more than 4 carbon atoms in the ester group are preferred, such as methyl esters, ethyl esters, propyl esters and butyl esters. Particularly advantageously, the methyl esters of α-sulfo fatty acid (MES) are used, but also the saponified di-salts thereof. Further suitable anionic surfactants are sulfated fatty acid glycerol esters, which represent the monoesters, diesters and triesters and the mixtures thereof, as they are obtained during production by way of the esterification of a monoglycerol with 1 to 3 moles fatty acid or during the transesterification of triglycerides with 0.3 to 2 moles glycerol. The alkali salts, and in particular the sodium salts of the sulfuric acid half-esters of C₁₂ to C₁₈ fatty alcohols, for example from coconut fatty alcohol, tallow fatty alcohol, lauryl, myristyl, cetyl or stearyl alcohol, or of C₁₀ to C₂₀ oxoalcohols and the half-esters of secondary alcohols having this chain length are preferred alk(en)yl sulfates. Furthermore preferred are alk(en)yl sulfates having the described chain length that comprise a synthetic straight-chain alkyl group produced on a petrochemical basis, and that have a similar degradation behavior as the adequate compounds based on fatty chemical raw materials. From a washing perspective, the C₁₂ to C₁₆ alkyl sulfates, C₁₂ to C₁₅ alkyl sulfates, and C₁₄ to C₁₅ alkyl sulfates are preferred. The sulfuric acid monoesters of straight-chain or branched C₇-C₂₁ alcohols ethoxylated with 1 to 6 moles of ethylene oxide, such as 2-methyl-branched C₉-C₁₁ alcohols comprising, on average, 3.5 moles ethylene oxide (EO) or C₁₂-C₁₈ fatty alcohols comprising 1 to 4 EO, are also suited. The preferred anionic surfactants also include the salts of alkyl sulfosuccinic acid, which are also referred to as sulfosuccinates or as sulfosuccinic acid esters and represent monoesters and/or diesters of sulfosuccinic acid with alcohols, preferably fatty alcohols, and in particular ethoxylated fatty alcohols. Preferred sulfosuccinates comprise C₈ to C₁₈ fatty alcohol groups or mixtures of these. In particular, preferred sulfosuccinates comprise a fatty alcohol group that is derived from ethoxylated fatty alcohols, which taken alone represent non-ionic surfactants. Among these, in turn, sulfosuccinates comprising fatty alcohol groups that derive from ethoxylated fatty alcohols exhibiting a restricted distribution of homologs are particularly preferred. Likewise, it is also possible to use alk(en)yl succinic acid having preferably 8 to 18 carbon atoms in the alk(en)yl chain, or the salts thereof. Further possible anionic surfactants are fatty acid derivatives of amino acids, such as of N-methyltaurine (taurides) and/or of N-methylglycine (sarcosides). In particular, the sarcosides or sarcosinates are preferred, and among these especially sarcosinates of higher and optionally monounsaturated or polyunsaturated fatty acids, such as oleyl sarcosinate. Further anionic surfactants that can also be used are in particular soaps. In particular, saturated fatty acid soaps are suitable, such as the salts of lauric acid, myristic acid, palmitic acid, stearic acid, hydrogenated erucic acid and behenic acid, and in particular soap mixtures derived from natural fatty acids, such as coconut, palm kernel, or tallow fatty acids. Together with these soaps or as a substitute for soaps, it is also possible to use the known alkenyl succinic acid salts.

The anionic surfactants, including the soaps, can be present in the form of the sodium, potassium or ammonium salts thereof, or as soluble salts of organic bases, such as monoethanolamine, diethanolamine or triethanolamine. The anionic surfactants are preferably present in the form of the sodium or potassium salts thereof, and in particular in the form of the sodium salts. Surfactants are normally present in the laundry detergents in proportions of about 1 wt. % to about 50 wt. %, and in particular of about 5 wt. % to about 30 wt. %.

A laundry detergent preferably comprises at least one water-soluble and/or water-insoluble, organic and/or inorganic builder. The water-soluble organic builder substances include polycarboxylic acids, in particular citric acid, saccharic acids, monomeric and polymeric aminopolycarboxylic acids, in particular glycine diacetic acid, methylglycine diacetic acid, nitrilotriacetic acid, iminodisuccinates such as ethylenediamine-N,N′-disuccinic acid and hydroxyiminodisuccinates, ethylenediaminetetraacetic acid and polyaspartic acid, polyphosphonic acids, in particular aminotris(methylenephosphonic acid), ethylenediaminetetrakis(methylenephosphonic acid), lysine tetra(methylenephosphonic acid) and 1-hydroxyethane-1,1-diphosphonic acid, polymeric hydroxy compounds such as dextrin and polymeric (poly-)carboxylic acids, in particular polycarboxylates accessible by oxidation of polysaccharides, polymeric acrylic acids, methacrylic acids, maleic acids, and mixed polymers of the same, which may also have small fractions of polymerizable substances having no carboxylic acid functionality polymerized into the same. The relative average molar mass of the homopolymers of unsaturated carboxylic acids is generally between about 5,000 g/mol and about 200,000 g/mol, that of the copolymers is between about 2,000 g/mol and about 200,000 g/mol, preferably about 50,000 g/mol to about 120,000 g/mol, each based on free acid. A particularly preferred acrylic acid/maleic acid copolymer has a relative average molar mass of about 50,000 to about 100,000. Suitable, albeit less preferred compounds of this class are copolymers of acrylic acid or methacrylic acid with vinyl ethers, such as vinyl methyl ethers, vinyl esters, ethylene, propylene and styrene, in which the proportion of the acid is at least 50 wt. %. It is also possible to use terpolymers comprising two unsaturated acids and/or the salts thereof as the monomers, and vinyl alcohol and/or a vinyl alcohol derivative or a carbohydrate as the third monomer, as water-soluble organic builder substances. The first acid monomer or the salt thereof is derived from a monoethylenically unsaturated C₃-C₈ carboxylic acid and preferably from a C₃-C₄ monocarboxylic acid, in particular from (meth)acrylic acid. The second acid monomer or the salt thereof can be a derivative of a C₄-C₈ dicarboxylic acid, wherein maleic acid is particularly preferred. The third monomeric unit is formed in this case by vinyl alcohol and/or preferably an esterified vinyl alcohol. In particular, vinyl alcohol derivatives which represent an ester of short-chain carboxylic acids, for example of C₁-C₄ carboxylic acids, with vinyl alcohol are preferred. Preferred polymers comprise about 60 wt. % to about 95 wt. %, in particular about 70 wt. % to about 90 wt. %, (meth)acrylic acid or (meth)acrylate, particularly preferably acrylic acid or acrylate, and maleic acid or maleinate, and about 5 wt. % to about 40 wt. %, preferably about 10 wt. % to about 30 wt. %, vinyl alcohol and/or vinyl acetate. Especially particularly preferred are polymers in which the weight ratio of (meth)acrylic acid or (meth)acrylate to maleic acid or maleinate ranges between about 1:1 and about 4:1, preferably between about 2:1 and about 3:1, and in particular about 2:1 and about 2.5:1. Both the amounts and the weight ratios are based on the acids. The second acid monomer or the salt thereof can also be a derivative of an allyl sulfonic acid, which at the 2-position is substituted with an alkyl group, preferably a C₁-C₄ alkyl group, or an aromatic group, which is preferably derived from benzene or benzene derivatives. Preferred terpolymers comprise about 40 wt. % to about 60 wt. %, in particular about 45 wt. % to about 55 wt. %, (meth)acrylic acid or (meth)acrylate, particularly preferably acrylic acid or acrylate, about 10 wt. % to about 30 wt. %, preferably about 15 wt. % to about 25 wt. %, methallyl sulfonic acid or methallyl sulfonate, and, as the third monomer, about 15 wt. % to about 40 wt. %, preferably about 20 wt. % to about 40 wt. % of a carbohydrate. This carbohydrate can be a mono-, di-, oligo- or polysaccharide, for example, wherein mono-, di- or oligosaccharides are preferred. Sucrose is particularly preferred. As a result of the use of the third monomer, predetermined breaking points are presumably introduced into the polymer, which are responsible for the good biodegradability of the polymer. These terpolymers generally have a relative average molecular mass between about 1,000 g/mol and about 200,000 g/mol, preferably between about 200 g/mol and about 50,000 g/mol. Further preferred copolymers are those that comprise acrolein and acrylic acid/acrylic acid salts or vinyl acetate as monomers. The organic builder substances can be used in the form of aqueous solutions, and preferably in the form of about 30 to about 50 percent by weight aqueous solutions, in particular for the production of liquid detergents. All aforementioned acids are generally used in the form of the water-soluble salts thereof, in particular the alkali salts thereof.

Such organic builder substances can be present in amounts of up to 40 wt. %, in particular up to 25 wt. %, and preferably from about 1 wt. % to about 8 wt. %, if desired. Amounts close to the aforementioned upper limit are preferably used for pasty or liquid, in particular hydrous, agents.

Water-soluble inorganic builder materials that can be used are in particular polyphosphates, and preferably sodium triphosphate. Water-insoluble inorganic builder materials that are used are in particular crystalline or amorphous, water-dispersible alkali aluminosilicates, in amounts not above 25 wt. %, preferably from about 3 wt. % to about 20 wt. %, and in particular in amounts from about 5 wt. % to about 15 wt. %. Among these, the crystalline sodium aluminosilicates in detergent quality, in particular zeolite A, zeolite P and zeolite MAP, and optionally zeolite X, are preferred. Amounts close to the aforementioned upper limit are preferably used for solid, particulate agents. Suitable aluminosilicates in particular comprise no particles having a particle size above 30 μm, and preferably have a content of at least 80 wt. % of particles having a size of less than 10 μm. The calcium-binding capacity is generally in the range of about 100 to about 200 mg CaO per gram.

In addition or as an alternative to the described water-insoluble aluminosilicate and alkali carbonate, further water-soluble inorganic builder materials may be present. In addition to the polyphosphates such as sodium triphosphate, these include in particular the water-soluble crystalline and/or amorphous alkali silicate builders. The detergents preferably comprise such water-soluble inorganic builder materials in amounts of about 1 wt. % to about 20 wt. %, in particular about 5 wt. % to about 15 wt. %. The alkali silicates that can be used as builder materials preferably have a molar ratio of alkali oxide to SiO₂ of less than 0.95, in particular of about 1:1.1 to about 1:12 and can be present in amorphous or crystalline form. Preferred alkali silicates are sodium silicates, in particular the amorphous sodium silicates, having a molar ratio of Na₂O:SiO₂ of about 1:2 to about 1:2.8. Crystalline silicates that are used, which may be present either alone or in a mixture with amorphous silicates, are preferably crystalline phyllosilicates of general formula Na₂SiₓO₂ₓ₋₁·y H₂O, where x, the so-called module, is a number from about 1.9 to about 4, and y is a number from 0 to 20, and preferred values for x are 2, 3 or 4. Preferred crystalline phyllosilicates are those in which x in the above-mentioned general formula takes on the value 2 or 3. In particular, both β- and δ-sodium disilicates (Na₂Si₂O₅·y H₂O) are preferred. Practically anhydrous crystalline alkali silicates, produced from amorphous alkali silicates, of the above general formula, in which x denotes a number from about 1.9 to about 2.1, can also be used in the detergents. In a further preferred embodiment, a crystalline sodium phyllosilicate having a module from 2 to 3 is used, as it can be produced from sand and soda. Sodium silicates having a module in the range from about 1.9 to about 3.5 are used in a further embodiment. In a preferred embodiment of such detergents, a granular compound composed of alkali silicate and alkali carbonate is used, as it is commercially available under the name Nabion® 15, for example.

The detergents can comprise peroxygen-based bleaching agents, in particular if they are used in connection with activation component comprising a UV radiation source. Possible suitable peroxygen compounds include in particular organic peroxy acids or peracid salts of organic acids, such as phthalimidopercaproic acid, perbenzoic acid, monoperoxyphthalic acid and diperdodecanoic diacid and the salts thereof, such as magnesium monoperoxyphthalate, hydrogen peroxide and inorganic salts giving off hydrogen peroxide under the usage conditions, such as alkali perborate, alkali percarbonate and/or alkali persilicate, and hydrogen peroxide clathrates, such as H₂O₂ urea adducts. Hydrogen peroxide may also be created by way of an enzymatic system, which is to say an oxidase and the substrate thereof. To the extent that solid peroxygen compounds are to be used, these may be used in the form of powders or granules, which may also be coated in the manner known per se. Particularly preferably, alkali percarbonate, alkali perborate monohydrate or hydrogen peroxide is used in the form of aqueous solutions comprising 3 wt. % to 10 wt. % hydrogen peroxide. If a laundry detergent used within the scope of the disclosure comprises peroxygen compounds, these are preferably present in amounts of up to 50 wt. %, in particular of about 2 wt. % to about 45 wt. %, and particularly preferably of about 5 wt. % to about 20 wt. %. Preferred peroxygen concentrations (calculated as H₂O₂) in the liquor are in the range of about 0.001 g/l to about 10 g/l, in particular o about f 0.02 g/l to about 1 g/l, and particularly preferably of about 0.03 g/l to about 0.5 g/l, in particular when the activation component are UV radiation sources.

In particular, compounds that, under perhydrolysis conditions, yield optionally substituted perbenzoic acid and/or aliphatic peroxocarboxylic acids having 1 to 12 carbon atoms, and in particular 2 to 4 carbon atoms, either alone or in mixtures, can be used as compounds that enhance a bleaching process, but in contrast to an organic bleach enhancer compound, yield peroxocarboxylic acid under perhydrolysis conditions, in addition to the organic bleach enhancer compound, and in particular the compound according to general formula (I). Suitable bleach activators are those that carry O- and/or N-acyl groups, in particular having the described carbon atomic number and/or optionally substituted benzoyl groups. Polyacylated alkylenediamines, in particular tetra acetyl ethylene diamine (TAED), acylated glycolurils, in particular tetraacetyl glycoluril (TAGU), acylated triazine derivatives, in particular 1,5-diacetyl-2,4-dioxohexahydro-1,3,5-triazine (DADHT), N-acyl imides, in particular N-nonanoyl succinimide (NOSI), acylated phenolsulfonates or phenolcarboxylates or the sulfonic or carboxylic acids of these, in particular nonanoyl or iso-nonanoyl or lauroyl oxybenzene sulfonate (NOBS or iso-NOBS or LOBS), or decanoyloxybenzoate (DOBA), the formal carboxylic acid ester derivatives thereof, such as 4-(2-decanoyloxyethoxycarbonyloxy)benzene sulfonate (DECOBS), acylated polyhydric alcohols, in particular triacetin, ethylene glycol diacetate and 2,5-diacetoxy-2,5-dihydrofuran, and acetylated sorbitol and mannitol and the mixtures thereof (SORMAN), acylated sugar derivatives, in particular penta-acetyl glucose (PAG), penta-acetyl fructose, tetra-acetyl xylose and octa-acetyl lactose, acetylated, optionally N-alkylated glucamine and gluconolactone, and/or N-acylated lactams, for example N-benzoyl caprolactam, are preferred.

In addition to the compounds that, under perhydrolysis conditions, form peroxocarboxylic acids, further bleach-activating compounds, such as nitriles, which yield perimidic acids under perhydrolysis conditions, may be present. These include in particular aminoacetonitrile derivatives comprising a quaternized nitrogen atom according to formula

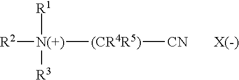

in which R¹ denotes —H, —CH₃, a C₂₋₂₄ alkyl or alkenyl group, a substituted C₁₋₂₄ alkyl group or C₂₋₂₄ alkenyl group comprising at least one substituent from the group —Cl, —Br, —OH, —NH₂, CN and —N⁽⁺⁾—CH₂—CN, an alkyl or alkenyl aryl group having a C₁₋₂₄ alkyl group, or a substituted alkyl or alkenyl aryl group having at least one, preferably two, optionally substituted C₁₋₂₄ alkyl groups and optionally further substituents on the aromatic ring, R² and R³, independently of one another, are selected from —CH₂—CN, —CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂—CH(OH)—CH₃, —CH(OH)—CH₂—CH₃, —(CH₂CH₂—O)ₙH, where n=1, 2, 3, 4, 5 or 6, R⁴ and R⁵, independently of one another, have a meaning stated above for R¹, R² or R³, wherein at least two of the aforementioned groups, in particular R₂ and R₃, may be linked to one another so as to close the ring, including the nitrogen atom and optionally further heteroatoms, and then preferably form a morpholino ring, and X is a charge-equalizing anion, preferably selected from benzene sulfonate, toluene sulfonate, cumol sulfonate, the C₉₋₁₅ alkylbenzene sulfonates, the C₁₋₂₀ alkyl sulfates, the C₈₋₂₂ carboxylic acid methyl ester sulfonates, sulfate, hydrogen sulfate, and the mixture thereof, can be used. Bleach activators forming peroxocarboxylic acids or perimidic acids under perhydrolysis conditions are preferably present in amounts over 0 wt. % up to 10 wt. %, in particular about 1.5 wt. % to about 5 wt. % in the laundry detergents used within the scope of the disclosure.

The presence of bleach-catalyzing transition metal complexes is also possible. These are preferably selected among the cobalt, iron, copper, titanium, vanadium, manganese and ruthenium complexes. Possible ligands in such transition metal complexes are either inorganic or organic compounds, which in addition to carboxylates, include in particular compounds having primary, secondary and/or tertiary amine and/or alcohol functions, such as pyridine, pyridazine, pyrimidine, pyrazine, imidazole, pyrazole, triazole, 2,2″-bispyridyl amine, tris-(2-pyridylmethyl)amine, 1,4,7-triazacyclononane, 1,4,7-trimethyl-1,4,7-triazacyclononane, 1,5,9-trimethyl-1,5,9-triazacyclododecane, (bis-((1-methylimidazol-2-yl)-methyl))-(2-pyridylmethyl)amine, N,N′-(bis-(1-methylimidazol-2-yl)-methyl)ethylenediamine, N-bis-(2-benzimidazolylmethyl)aminoethanol, 2,6-bis-(bis-(2-benzimidazolylmethyl)aminomethyl)-4-methylphenol, N,N,N′,N′-tetrakis-(2-benzimidazolylmethyl)-2-hydroxy-1,3-diaminopropane, 2,6-bis-(bis-(2-pyridyl-methyl)aminomethyl)-4-methylphenol, 1,3-bis-(bis-(2-benzimidazolylmethyl)aminomethyl)benzene, sorbitol, mannitol, erythritol, adonitol, inositol, lactose, and optionally substituted salenes, porphins and porphyrins. The inorganic neutral ligands include in particular ammonia and water. If not all coordination sites of the central transition metal atom are occupied by neutral ligands, the complex comprises further, preferably anionic and, among these, in particular monodentate or bidentate, ligands. These include in particular the halides, such as fluoride, chloride, bromide and iodide, and the (NO₂)⁻ group, which is to say a nitro ligand or a nitrito ligand. The (NO₂)⁻ group can also be bound to a transition metal in a chelating manner, or it may asymmetrically or η¹-O bridge two transition metal atoms. In addition to the above-mentioned ligands, the transition metal complexes can carry further ligands, which generally have simpler structures, and in particular monovalent or polyvalent anionic ligands. For example, nitrate, acetate, trifluoroacetate, formate, carbonate, citrate, oxalate, perchlorate and complex anions such as hexafluorophosphate may be used. The anionic ligands are to ensure the charge equalization between the central transition metal atom and the ligand system. The presence of oxo ligands, peroxo ligands and imino ligands is also possible. In particular, these ligands may also have a bridging effect, whereby multinuclear complexes are created. In the case of bridged, binuclear complexes, the two metal atoms in the complex do not have to be identical. It is also possible to use binuclear complexes in which the two central transition metal atoms have differing oxidation numbers. If anionic ligands are absent or the presence of anionic ligands does not result in charge equalization in the complex, anionic counterions are present in the transition metal complex compounds to be used as contemplated herein, which neutralize the cationic transition metal complex. These anionic counterions include in particular nitrate, hydroxide, hexafluorophosphate, sulfate, chlorate, perchlorate, the halides such as chloride, or the anions of carboxylic acids such as formate, acetate, oxalate, benzoate or citrate. Examples of transition metal complex compounds that can be used are Mn(IV)₂(μ-O)₃(1,4,7-trimethyl-1,4,7-triazacyclononane)-di-hexafluorophosphate, [N,N′-bis[(2-hydroxy-5-vinylphenyl)-methylene]-1,2-diaminocyclohexane] manganese(III) chloride, [N,N′-bis[(2-hydroxy-5-nitrophenyl)-methylene]-1,2-diaminocyclohexane] manganese(III) acetate, [N,N′-bis[(2-hydroxyphenyl)-methylene]-1,2-phenylenediamine] manganese(III) acetate, [N,N′-bis[(2-hydroxyphenyl)-methylene]-1,2-diaminocyclohexane] manganese(III) chloride, [N,N′-bis[(2-hydroxyphenyl)-methylene]-1,2-diaminoethane] manganese(III) chloride, [N,N′-bis[(2-hydroxy-5-sulfonatophenyl)-methylene]-1,2-diaminoethane] manganese(III) chloride, manganese oxalate complexes, nitropentammine cobalt(III) chloride, nitritopentammine cobalt(III) chloride, hexammine cobalt(III) chloride, chloropentammine cobalt(III) chloride and the peroxo complex [(NH₃)₅Co—O—O—Co(NH₃)₅]Cl₄.

Enzymes that can be used in the detergents include those of the class of amylases, proteases, lipases, cutinases, pullulanases, hemicellulases, cellulases, oxidases, laccases and peroxidases, and the mixtures thereof. Particularly suited are enzymatic active ingredients obtained from fungi or bacteria, such as Bacillus subtilis, Bacillus licheniformis, Bacillus lentus, Streptomyces griseus, Humicola lanuginosa, Humicola insolens, Pseudomonas pseudoalcaligenes, Pseudomonas cepacia or Coprinus cinereus. The enzymes can be adsorbed on carrier substances and/or be embedded in coating substances to protect them against premature inactivation. These are preferably present in the laundry detergents or cleaning agents as contemplated herein in amounts of up to 5 wt. %, and in particular of about 0.2 wt. % to about 4 wt. %. If the detergent as contemplated herein comprises protease, this preferably has a proteolytic activity in the range of approximately 100 PE/g to approximately 10,000 PE/g, and in particular about 300 PE/g to about 8000 PE/g. If several enzymes are to be used in the detergent as contemplated herein, this may be carried out by incorporating two or more enzymes that are separate or separately formulated in the known manner, or by two or more enzymes that are formulated together in granules.

The organic solvents that can be used, in addition to water, in the laundry detergents, in particular if these are present in liquid or pasty form, include alcohols having 1 to 4 carbon atoms, in particular methanol, ethanol, isopropanol, and tert. butanol., diols having 2 to 4 carbon atoms, in particular ethylene glycol and propylene glycol, and the mixtures thereof and the ethers derivable from the above-mentioned compound classes. Such water-miscible solvents are preferably present in the detergents as contemplated herein in amounts not above 30 wt. %, in particular of about 6 wt. % to about 20 wt. %.

To set a desired pH value that does not result on its own by virtue of mixing the remaining components, the detergents as contemplated herein can comprise system compatible and environmentally compatible acids, in particular citric acid, acetic acid, tartaric acid, malic acid, lactic acid, glycolic acid, succinic acid, glutaric acid and/or adipic acid, but also mineral acids, in particular sulfuric acid, or bases, in particular ammonium or alkali hydroxides. Such pH regulators are preferably present in the detergents as contemplated herein in amounts not above 20 wt. %, in particular of about 1.2 wt. % to about 17 wt. %.

The task of graying inhibitors is to maintain the dirt dissolved from the textile fibers suspended in the liquor. Water-soluble colloids, usually of an organic nature, are suitable for this purpose, such as starch, glue, gelatin, salts of ether carboxylic acids or ether sulfonic acids of starch or cellulose, or salts of acidic sulfuric acid esters of cellulose or starch. Water-soluble, acidic group-comprising polyamides are also suitable for this purpose. Furthermore, starch derivatives other than those mentioned above may be used, for example aldehyde starches. The use of cellulose ethers, such as carboxymethyl cellulose (Na salt), methyl cellulose, hydroxyalkyl cellulose and mixed ethers, such as methyl hydroxyethyl cellulose, methyl hydroxypropyl cellulose, methyl carboxymethyl cellulose and the mixtures thereof, for example in amounts of 0.1 to 5 wt. %, based on the agents, is preferred.

If desired, the detergents can comprise a customary dye transfer inhibitor, preferably in amounts of up to 2 wt. %, and in particular of about 0.1 wt. % to about 1 wt. %, which in a preferred embodiment is selected from the polymers of vinylpyrrolidone, vinylimidazole, vinylpyridine-N-oxide, or the copolymers of these. It is possible to use both polyvinylpyrrolidones having molecular weights of about 15,000 g/mol to about 50,000 g/mol and polyvinylpyrrolidones having higher molecular weights of more than 1,000,000 g/mol, and in particular of about 1,500,000 g/mol to about 4,000,000 g/mol, for example, N-vinylimidazole/N-vinylpyrrolidone copolymers, polyvinyloxazolidones, copolymers based on vinyl monomers and carboxylic acid amides, pyrrolidone group-comprising polyesters and polyamides, grafted polyamidoamines and polyethylene imines, polyamine-N-oxide polymers and polyvinyl alcohols. However, it is also possible to use enzymatic systems, comprising a peroxidase and hydrogen peroxide or a substance yielding hydrogen peroxide in water. The addition of a mediator compound for the peroxidase, for example of an acetosyringone, a phenol derivative or a phenothiazine or phenoxazine, is preferred in this case, wherein in addition the above-mentioned polymeric dye transfer inhibitor active ingredients can also be used. Polyvinylpyrrolidone preferably has an average molar mass in the range of about 10,000 g/mol to about 60,000 g/mol, and in particular in the range of about 25,000 g/mol to about 50,000 g/mol. Among the copolymers, those composed of vinylpyrrolidone and vinylimidazole in a molar ratio of about 5:1 to about 1:1, having an average molar mass in the range of about 5,000 g/mol to about 50,000 g/mol, and in particular of about 10,000 g/mol to about 20,000 g/mol, are preferred. In preferred embodiments of the disclosure, however, the laundry detergents are free from such added dye transfer inhibitors.

Laundry detergents can comprise derivatives of diaminostilbene disulfonic acid or the alkali metal salts thereof, for example, as optical brighteners, although they are preferably free from optical brighteners when used as color laundry detergents. For example, salts of 4,4′-bis(2-anilino-4-morpholino-1,3,5-triazinyl-6-amino)stilbene-2,2′-disulfonic acid or similarly structured compositions are suitable, which carry a diethanolamino group, a methylamino group, an anilino group or a 2-methoxyethylamino group instead of the morpholino group. Moreover, brighteners of the type of substituted diphenylstyryls can be present, for example the alkali salts of 4,4′-bis(2-sulfostyryl)biphenyl, 4,4′-bis(4-chloro-3-sulfostyryl)biphenyl, or 4-(4-chlorostyryl)-4′-(2-sulfostyryl)biphenyls. It is also possible to use mixtures of the aforementioned optical brighteners.

In particular when used with mechanical processes, it may be advantageous to add customary foam inhibitors to the detergents. For example, soaps of natural or synthetic origin having a high content of C₁₈-C₂₄ fatty acids are suitable foam inhibitors. Suitable non-surfactant-type foam inhibitors are, for example, organopolysiloxanes and the mixtures thereof with micro-fine, optionally silanized silica and paraffins, waxes, microcrystalline waxes and the mixtures thereof with silanized silica or bis-fatty acid alkylene diamides. Advantageously, mixtures of different foam inhibitors are also used, for example those composed of silicones, paraffins or waxes. The foam inhibitors, and in particular silicone-comprising and/or paraffin-comprising foam inhibitors, are preferably bound to a granular carrier substance that is soluble or dispersible in water. In particular, mixtures of paraffins and ethylene distearylamide are preferred.

The production of solid detergents does not pose any difficulties and be carried out in the known manner, for example by spray drying or granulation, wherein enzymes and potential further thermally sensitive ingredients, such as bleaching agents, are optionally added separately later. To produce detergents having increased bulk density, in particular in the range of 650 g/L to 950 g/L, a method comprising an extrusion step is preferred.

So as to produce detergents in tablet form, which can be single-phase or multi-phase, single-color or multi-color and in particular can be composed of one layer or of multiple, in particular of two, layers, the procedure is preferably such that all components—optionally of a respective layer—are mixed with each other in a mixer, and the mixture is compressed using conventional tablet presses, such as eccentric presses or rotary tablet presses, using pressures in the range of approximately about 50 to about 100 kN, preferably about 60 to about 70 kN. In particular, in the case of multi-layer tablets, it may be advantageous if at least one layer is pre-compressed. This is preferably carried out at pressures between about 5 and about 20 kN, and in particular at about 10 to about 15 kN. This readily yields break-resistant tablets that nonetheless dissolve sufficiently quickly under usage conditions, with breaking and flexural strengths of normally about 100 to about 200 N, preferably however above 150 N. A tablet thus produced preferably has a weight of about 10 g to about 50 g, in particular of about 15 g to about 40 g. The physical shape of the tablets is arbitrary and can be round, oval or angular, intermediate shapes also being possible. Corners and edges are advantageously rounded. Round tablets preferably have a diameter of about 30 mm to about 40 mm. In particular, the size of angular or cuboid tablets, which are predominantly introduced via the dosing device of the washing machine, is dependent on the geometry and the volume of this dosing device. Preferred embodiments by way of example have a base area of (20 to 30 mm)×(34 to 40 mm), and in particular of about 26×36 mm or of about 24×38 mm.

Liquid or pasty detergents in the form of solutions comprising customary solvents are generally produced by simple mixing of the ingredients, which can be placed into an automatic mixer in substance or as a solution.

### EXAMPLES

### Example 1

The internal salt of sulfuric acid mono-[2-(3,4-dihydro-isoquinolin-2-yl)-1-(2-ethylhexyloxy-methyl)-ethyl] ester was prepared as in Example 4 of WO 03/104199 A2. An aqueous solution comprising 16 ppm of the dye Acid Blue 113 was mixed with the aforementioned dihydroisoquinoline compound, so that the concentration thereof was 50 mg/L, and was electrolyzed for 3 hours at 23° C. and a pH of 2.5 at a potential difference of 1.35 V (Ag/AgCl) using a working electrode made of boron-doped graphite and a counter electrode made of stainless steel. For comparison, the same solution was electrolyzed under the same conditions without adding the dihydrosioquinoline. Thereafter, the concentration of the dye in each solution was photometrically (wavelength 548 nm) determined. In the dihydroisoquinoline-comprising solution, the breakdown of the dye was 10% higher than in the solution without the compound. Neither in the absence nor in the presence of the dihydroisoquinoline compound was a decomposition of the dye observed in solutions that were kept without electrolysis for an identical duration for comparison purposes.

### Example 2

Example 1 was repeated, except that now no electrolysis device was used, but the aqueous solutions, which had previously been mixed with H₂O₂ (to a concentration of 10 mmol/l), were exposed for 10 minutes to radiation of a UV lamp (supplier Benda, Wiesloch; type NU-15 KL, 220 volt, 15 watt, 1 ampere; wavelength set to 254 nm). In the dihydroisoquinoline-comprising solution, the breakdown of the dye was 21.4% higher than in the solution without the compound.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the various embodiments in any way. Rather, the foregoing detailed description will provide those skilled in the art with a convenient road map for implementing an exemplary embodiment as contemplated herein. It being understood that various changes may be made in the function and arrangement of elements described in an exemplary embodiment without departing from the scope of the various embodiments as set forth in the appended claims.

1. A method for laundering textiles in a washing machine comprising a washing chamber for receiving a washing liquid and textiles to be cleaned, and comprising an activation device, which includes an inlet for introducing washing liquid from the washing chamber into the activation device and an outlet for conducting washing liquid out of the activation device into the washing chamber, and which additionally comprises at least one activation means component suitable for triggering a process within the activation device for forming free radicals in the washing liquid, comprising the following steps:
adding the textiles to be washed into the washing chamber of the washing machine;
starting a washing cycle;
introducing washing liquid from the washing chamber into the activation device;
triggering a process in the activation device for forming free radicals in the washing liquid;
breaking down dyes present in the washing liquid by way of the free radicals;
conducting treated washing liquid out of the decolorization reservoir into the washing chamber,
wherein the washing liquid comprises an organic bleach enhancer compound.

2. (canceled)

3. The method according to claim 1, wherein the organic bleach enhancer compound is selected from the compounds of general formula (I), 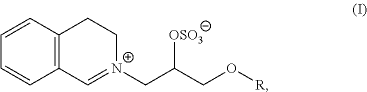
in which R denotes a straight-chain or branched alkyl group having 2 to 20 carbon atoms, and the mixtures thereof.

4. The method according to claim 1, wherein the activation component comprises a UV radiation source and/or an electrode array, comprising an anode and a cathode.

5. The method according to claim 4, wherein a quartz lamp or a UV light-emitting diode is used as the UV radiation source.

6. The method according to claim 4, wherein the UV radiation source emits UV radiation in a wavelength range of about 100 nm to about 400 nm.

7. The method according to claim 4, wherein the anode in the electrode array is a possibly boron-doped diamond electrode.

8. The method according to claim 7, wherein the effective surface area of the anode is in the range of about 1 to about 500 cm².

9. The method according to claim 1, wherein the activation device is fixedly installed in a housing of the washing machine.

10. The method according to claim 1, wherein the washing liquid has a temperature in the range of about 10° C.

11. The method according to claim 1, wherein the concentration of the compound according to general formula (I) in the washing liquid is in the range of about 0.5 μmol/l to about 500 μmol/l.

12. The method according to claim 1, wherein a laundry detergent comprising the organic bleach enhancer compound is used to create the washing liquid.

13. The method according to claim 3, wherein the alkyl group R in the compounds according to general formula (I) is branched at the 2-position.

14. The method according to claim 1, wherein the organic bleach enhancer compound is selected from the compounds of general formula (I), 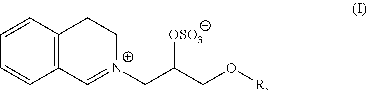
in which R denotes a straight-chain or branched alkyl group having 8 to 12 carbon atoms, and the mixtures thereof.

15. The method according to claim 4, wherein the UV radiation source emits UV radiation in a wavelength range of about 250 nm to about 400 nm.

16. The method according to claim 7, wherein the effective surface area of the anode is in the range of about 2 to about 100 cm².

17. The method according to claim 1, wherein the activation device is designed as a separate module.

18. The method according to claim 1, wherein the washing liquid has a temperature in the range of about 20° C. to about 60° C.

19. The method according claim 1, wherein the concentration of the compound according to general formula (I) in the washing liquid is in the range of about 5 μmol/l to about 100 μmol/l.

20. The method according to claim 1, wherein a laundry detergent comprising the organic bleach enhancer compound according to general formula (I) is used to create the washing liquid.

21. The method according to claim 3, wherein the alkyl group R in the compounds according to general formula (I) is selected from the 2-methylhexyl, 2-ethylhexyl, 2-ethylheptyl, 2-propylheptyl, 2-butyloctyl, 2-butylnonyl, 2-pentylnonyl, 2-pentyldecyl and 2-hexyldecyl group and mixtures of these.
